(19) United States
(12) Patent Application Publication
(10) Pub. No.: US 2003/0217056 A1
(43) Pub. Date: Nov. 20, 2003

(54) Method and computer program for collecting, rating, and making available electronic information

(75) Inventors: Ace Allen, Overland Park, KS (US); Susan Gauch, Lawrence, KS (US); Subhash Induri, Lawrence, KS (US); Scott McWilliams, Leawood, KS (US); Jim Patterson, Plaquemine, LA (US); Rajan Vijayaraghavan, Lawrence, KS (US)

Correspondence Address: HOVEY WILLIAMS LLP, 2405 GRAND BLVD., SUITE 400, KANSAS CITY, MO, 64108, US

(73) Assignee: Today Communications, Inc.

(21) Appl. No.: 10/395,329

(22) Filed: Mar. 24, 2003

Related U.S. Application Data
(60) Provisional application No. 60/367,635, filed on Mar. 25, 2002.

(51) Int. Cl. G06F 7/00

(52) U.S. Cl. 707/7

(57) ABSTRACT

A method and computer program for collecting, rating, and making available information on the World Wide Web and other information sources. The method broadly comprises the steps of: collecting information relating to a particular subject; rating the information; gathering additional information relating to the rated information; indexing the rated information; identifying and applying desired client-user parameters to the rated information; identifying and applying desired end-user parameters to the rated information; and if the rated information meets the client-user and end-user parameters, displaying at least one item of information meeting the client-user and end-user parameters. The method may further includes the steps of: managing the client-user account; and generating usage statistics. The computer program is broadly comprised of at least one source code module and at least one file, including a Rating Source Code Module and a Connectivity Source Code Module and a Site Identification File, a Mapping File, a Raw Scores File, a Rated Information File, an Index File, a Text File, a Title File, and a Client-User Parameters File.

### RELATED APPLICATIONS

The present application is related to and claims priority benefit of a copending provisional patent application titled “INTERNET SEARCH ENGINE, COMPUTER PROGRAM, AND METHOD FOR SEARCHING, FILTERING, AND MANAGING MEDICAL AND OTHER INFORMATION”, Serial No. 60/367,635, filed Mar. 25, 2002, the content of which is hereby incorporated into the present application by reference. Further, the provisional application titled “INTERNET SEARCH ENGINE, COMPUTER PROGRAM, AND METHOD FOR SEARCHING, FILTERING, AND MANAGING MEDICAL AND OTHER INFORMATION” Serial No. ______; Filed Mar. 21, 2003, is hereby incorporated into the present application by reference.

### BACKGROUND OF THE INVENTION

1. Field of the Invention

The present invention broadly relates to tools for retrieving information available on the World Wide Web (“WWW”) and other information sources. More particularly, the invention relates to a method and computer program for collecting, rating, and making available information on the WWW, wherein the information is rated using a rating technique and filtered at least once based on at least one parameter identified by an end-user and at least one parameter identified by an intermediary.

2. Description of the Prior Art

The World Wide Web (“WWW”) is broadly defined as the universe of information stored on computers connected to and accessible via the Internet. The WWW allows virtually anyone to provide information to and access information from others via the Internet. Although such easy access to information is what makes the WWW valuable, it also creates problems in identifying truly useful information, because so much information is available.

Numerous methods and computer programs designed to facilitate searching the multiplicity of information available on the WWW are currently available. Popular search engines, such as google.com and yahoo.com, enable a user to filter to a small degree the information on the WWW. For example, google.com uses a linking strategy combined with a key-word search to filter and retrieve information. The linking strategy counts the number of links to a particular website along with the importance of each link. For example, if webmd.com, a popular healthcare website, links to heartdisease.com, then a keyword search for “heart disease” using google.com's search engine would likely list heartdisease.com first or near-first because it matches the identified keywords, namely “heart disease,” and is linked by a popular website, namely webmd.com.

Google.com also offers an advanced search that allows a user to perform a boolean search for keywords, search by location of the keywords in the information, search for information in a particular language, search for information in a particular file format, and return information updated within a set period of time. However, even using these search parameters, combined with the above-described linking strategy, google.com's search engine retrieves information that is not specifically about the identified keyword and subject and consequently, not tailored to the user's needs. Thus, google.com's search engine often retrieves information irrelevant to the searched subject.

Yahoo.com uses and google.com offers a branching directory approach for filtering and retrieving information. For example, if a user searching for information relevant to heart disease uses yahoo.com's search engine, the user first selects a “health” link under “Info.” The user is then linked to a yahoo.com-sponsored health website. The user may next select popular health conditions, including “heart and related conditions.” The user is then linked to a yahoo.com-sponsored heart information website, from which the user must further search for information relating to heart disease, symptoms, prognosis, etc., including a keyword search, if desired. Due to the multiple webpages through which the user must link, yahoo.com's directory-style search engine is time-consuming to use. Further, the information is not necessarily tailored to the user's needs but instead is merely related to a general subject which the user is searching.

Due to the limited filtering of information, google.com, yahoo.com, and other prior art search engines retrieve a broad array of information which the user must evaluate on an individual basis. Thus, the user must link to each website containing the information, perform a cursory review to determine if the information is more than just merely related to the subject the user wishes to search, and then perform a more extensive analysis to determine if the information is relevant to particular questions, concerns, or needs of the user. This process is very time-consuming and frustrating for the user, and unfortunately, the process results in the user abandoning the search.

Due to these and other problems and disadvantages in the art of electronic information retrieval, an improved method and computer program is needed for retrieving electronic information that is rated and filtered to meet the needs of a user.

### SUMMARY OF THE INVENTION

The present invention overcomes the above-described and other problems and disadvantages by providing a method and computer program for collecting, rating, and making available information on the World Wide Web (“WWW”) and other information sources, wherein the information is rated using a rating technique and filtered at least once based on at least one parameter identified by an end-user and at least one parameter identified by an intermediary. In more detail, a plurality of information relating to a particular subject, such as healthcare, for example, is first collected. The information is then manually rated by a trained rater who is an employee of an administrator of the computer program of the present invention. Next, the information is automatically rated using the rating technique, which assigns at least one value to each item of information, wherein the value represents a content of at least one administrator parameter within the item of information. The information is then indexed based on at least one unique keyword appearing in the information, such as, for example, heart, obesity, diabetes, etc. The administrator may sell, license, or assign the method and computer program of the present invention to a client-user, such as a hospital, for example, that filters the rated information by applying at least one client-user parameter to the information. An end-user may further filter the rated information by applying at least one end-user parameter to the rated information.

The method of the present invention may be implemented using the computer program. A system for storing and accessing or executing the computer program broadly includes first and second communications networks; a network server; a client-user network server; at least one remote access terminal; and a terminal connected to the network server. The first and second communications networks are preferably the Internet, and the network server is connected to the first communications network and hosts an administrator website. The client-user network server is preferably connected to both the first and second communications networks and hosts a client-user website. At least one remote access terminal is in communication with the first communications network and is operable to transmit and receive data via the first communications network. Similarly, at least one remote access terminal is in communication with the second communications network and is operable to transmit and receive data via the second communications network. The end-user may access the computer program of the present invention either through the administrator website using the remote access terminal in communication with the first communications network or through the client-user website using the remote access terminal in communication with the second communications network The terminal is operable to access and communicate with the network server directly, without need of the first or second communications networks.

By constructing a method and computer program for collecting, rating, and making available information on the WWW, as described herein, numerous advantages are realized. For example, the method and computer program of the present invention allows the end-user to retrieve electronic information available on the WWW that is more relevant and tailored to the end-user's needs and desires than prior art search engines, including performing an initial rating so that the end-user may appropriately and accurately rely on the information. This drastically lessens the need for the end-user to cull, analyze, and interpret information about a particular topic.

Further, the present invention allows the end-user to retrieve electronic information relevant to a particular subject without requiring the end-user to link through multiple webpages to tailor the information to the end-user's needs.

Further yet, the present invention allows the end-user to filter the rated information by applying the end-user parameters. If the end-user accesses the computer program of the present invention through the client-user website, the client-user may also filter the rated information by applying the client-user parameters. Hence, the retrieved information is tailored to the particular needs of the end-user, as opposed to merely relating to the broad subject.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a block diagram depicting a system that may be used to implement a method and computer program of the preferred embodiment of the present invention;

FIG. 2 is a flow diagram depicting the method of collecting, rating, and making available electronic information using the computer program of the present invention;

FIG. 3 is a screen capture of an administrator website; and

FIG. 4 is a screen capture of a client-user account.

The drawing figures do not limit the present invention to the specific embodiment disclosed and described herein. The drawings are not necessarily to scale, emphasis instead being placed upon clearly illustrating the principles of the invention.

### DETAILED DESCRIPTION OF A PREFERRED EMBODIMENT

Referring to the figures, a method and computer program for collecting, rating, and making available information on the World Wide Web (“WWW”) and other information sources is shown and described constructed in accordance with a preferred embodiment of the present invention. Broadly, the information is first collected, rated, and indexed by an administrator. The information is collected either manually or using a webcrawler. The information is then rated based on a rating technique that assigns at least one value to the information, wherein the value represents a content of at least one administrator parameter within the item of information. The information is then indexed by at least one keyword. Once rated, a client-user may filter the rated information by identifying and applying at least one client user parameter. The client-user is preferably a client of the administrator and operates a website that hosts the present invention, as discussed in more detail below. An end-user may further filter the rated information by identifying and applying at least one end-user parameter.

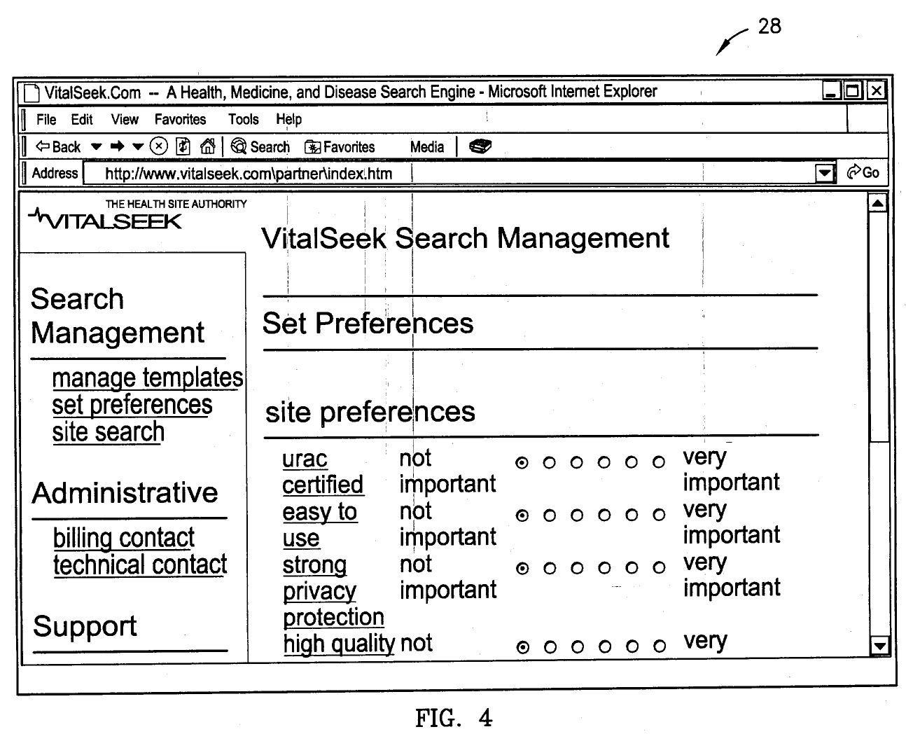

The method and computer program of the present invention also provides for account management capabilities that allow the client-user to manage a client-user account, as illustrated in FIG. 4, including managing their client-user parameters and importation and application of the computer program to the website operated by the client-user. Further, the method and computer program provides for statistics-generating capabilities for collecting information about, for example, usage patterns of the end-users using the computer program of the present invention.

In the preferred embodiment, described herein, the method of collecting, rating, and making available information on the WWW is implemented using the computer program comprising one or more fully-integrated source code modules and one or more files. The computer program is advantageously operable to select information from the WWW that is uniquely tailored to meet the parameters selected by the administrator, end-user, and client-user. This, in turn, reduces or even eliminates the time necessary to peruse and select relevant information from the multiplicity of information available on the WWW.

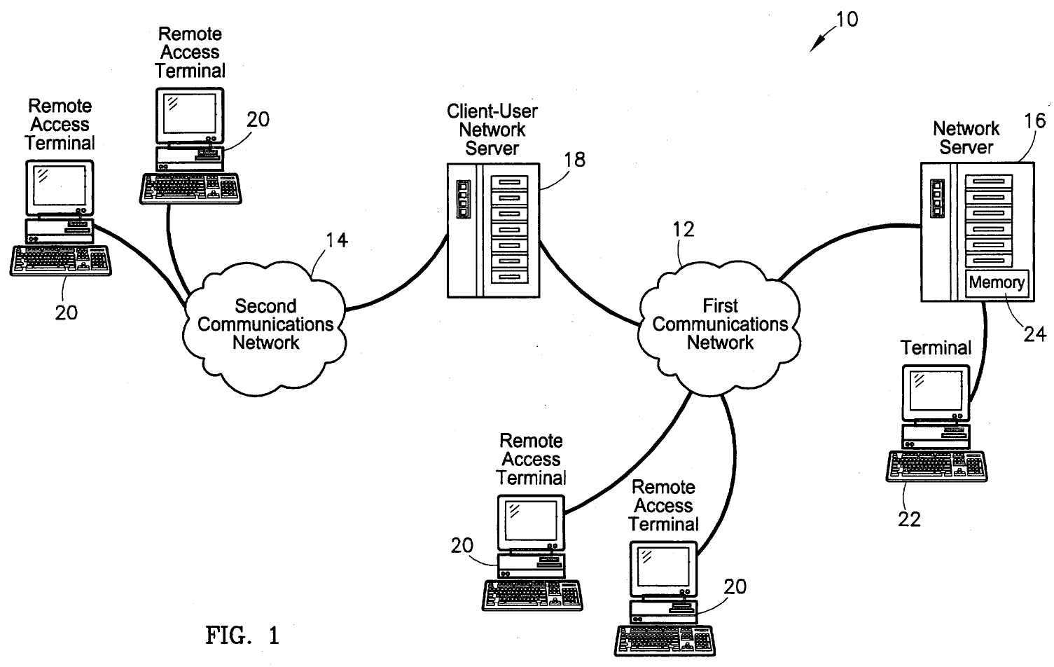

Referring to FIG. 1, a system 10 is shown operable to store or access and execute the computer program of the present invention. As illustrated, the system 10 broadly comprises first and second communications networks 12,14; a network server 16; a client-user network server 18; at least one remote access terminal 20; and a terminal 22 connected to the network server 16. The present invention is substantially independent of the individual components of the system 10, such that substantially any suitable components may be used so long as the system 10 as a whole is operable to practice the present invention as herein described, including performing the functions of storing and executing software and accessing and communicating with the network server 16 and client-user network server 18 via the first and second communications networks 12,14.

The first and second communications networks 12,14 each may be any substantially conventional communications or data transfer networks, such as, for example, a local area network (“LAN”), a wide area network (“WAN”), a wireless network, or an intranet. Preferably, the first and second communications networks 12,14 are the Internet, although the first communications network 12 may be the Internet and the second communications network 14 may be a LAN.

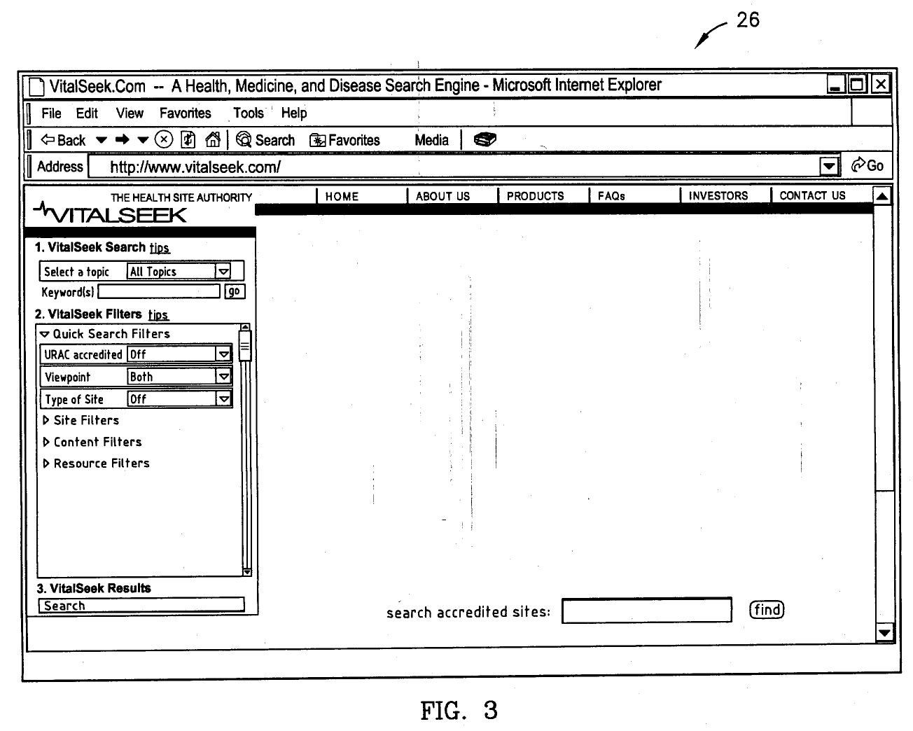

The network server 16 hosts a website 26, hereinafter referred to as the administrator website 26, that provides a first interface for the end-user to facilitate the end-user's interaction with the computer program, as described in more detail below and as illustrated in FIG. 3. The network server 16 is preferably administered by the administrator and is directly connected to the first communications network 12. The network server 16 may be any computing device such as a network computer running Windows NT, Novel Netware, Unix, or any other network operating system. The network server 16 includes conventional web hosting operating software, an Internet connection such as a modem, DSL converter or ISDN converter, and is assigned a URL and corresponding domain name such as “vitalseek.com” so that the administrator website 26 hosted thereon can be accessed via the first communications network 12 in a conventional manner.

The network server 16 preferably includes a memory 24 that is either resident in or accessible by the remote access terminal 20 and terminal 22. The memory 24 serves as a repository for the computer program and a plurality of files used to implement certain aspects of the present invention as described in more detail below.

The information is preferably accessible through or transferable across the first and second communications networks 12,14, and thus, is preferably in electronic form. The information may be, for example, documents, such as webpages. In preferable form, each document is locatable on the first and second communications networks 12,14 by a website address. The website address locates a website having at least one webpage that contains the information.

The client-user network server 18 is preferably connected to the first and second communications networks 12,14. In the preferred embodiment, because the first and second communications networks 12,14 are both the Internet, there need be only one communications network. However, alternative system 10 arrangements may require the second communications network 14 to be a LAN, and thus, the client-user network server 18 may be interposed between the first communications network 12, i.e. the Internet, and the second communications network 14, i.e. a LAN.

The client-user network server 18 hosts the website noted above, hereinafter referred to as the client-user website, that provides a second interface for the end-user to facilitate the end-user's interaction with the computer program, as described in more detail below. When the end-user accesses the computer program of the present invention via the client-user website, the second interface displays the information using a client-user template, as described below.

The client-user network server 18 is substantially similar to the network server 16 administered by the administrator. The client-user network server 18 may be any computing device such as a network computer running Windows NT, Novel Netware, Unix, or any other network operating system. The client-user network server 18 includes conventional web hosting operating software, an Internet connection such as a modem, DSL converter or ISDN converter, and is assigned a URL. The client-user website is preferably accessible via the second communications network 14 in a conventional manner.

The end-user may interact with the computer program either through the administrator website 26 or the client-user website using the remote access terminal 20. As such, the system 10 of the present invention preferably includes at least one remote access terminal 20, with at least one remote access terminal 20 independently operable to transmit and receive data via the first communications network 12, particularly data to and from the network server 16, and at least one remote access terminal 20 independently operable to transmit and receive data via the second communications network 14, particularly via the client-user network server 18.

The remote access terminal 20 may be any conventional computing device having network-accessible capabilities, including a conventional desktop personal computer, a conventional laptop or notebook computer, a conventional networked thin-client terminal, a mobile telephone, or a personal digital assistant (“PDA”). The remote access terminal 20 preferably includes conventional web hosting operating software and an Internet or other network connection such as a modem, DSL converter, or ISDN converter. The remote access terminal 20 may also be connected to other computing devices or provided with various conventional software, such as, for example, a firewall to prevent unauthorized tampering with information stored on or accessible by the remote access terminal 20.

The terminal 22 is substantially similar to the remote access terminal 20, except that the terminal 22 may be operable to access and communicate with the network server 16 directly, without need of the first or second communications networks 12,14. As described in more detail below, implementation of and changes to the administrator website 26 of the present invention and changes to the client-user account, including the client-user parameters, is accomplished using the terminal 20. The terminal 22 is preferably a conventional desktop personal computer or conventional laptop or notebook computer, but may alternatively be any other suitable computing device, such as, for example, a conventional networked thin-client terminal.

The administrator may sell, license, or assign the use of the present invention to the client-user, such as, for example, a hospital. In preferable form, multiple client-users each maintain their own client-user websites that implement the present invention, in addition to the administrator operating the administrator website 26. Therefore, the end-user may access the present invention either through the administrator website 26 or through the client-user website. As discussed below, if the end-user accesses the present invention through the client-user website, the retrieved information may be influenced, weighted, or otherwise manipulated by the end-user parameters.

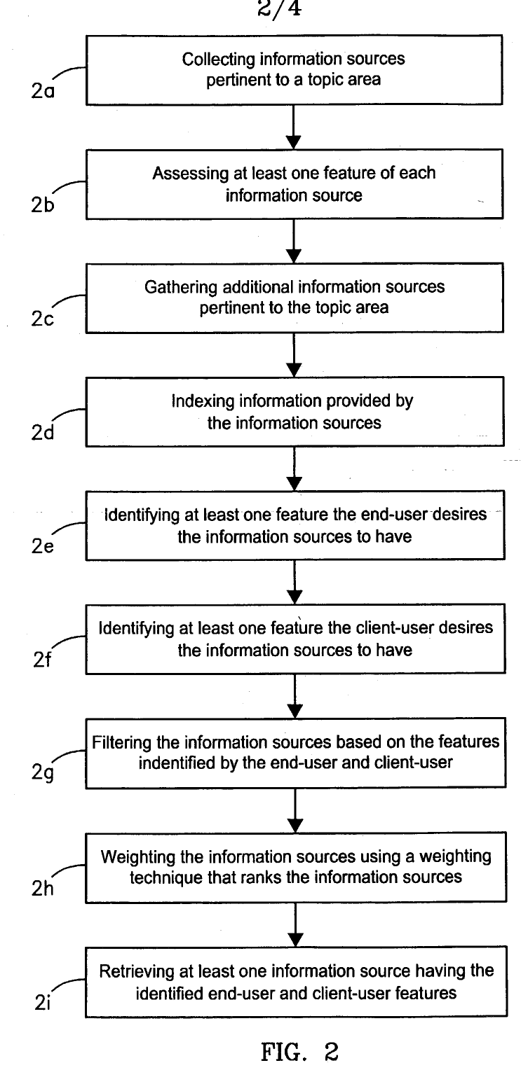

The flowchart of FIG. 2 shows the functionality and operation of the preferred implementation of the method of the present invention in more detail. In this regard, some of the blocks of the flowchart may represent a source code module segment or portion of source code of the computer program, as described in more detail below. In some alternative implementations, the functions noted in the various blocks may occur in an order which is different from that depicted in FIG. 2. For example, any two blocks shown in succession in FIG. 2 may in fact be executed substantially concurrently, or the blocks may sometimes be executed in reverse order depending upon the functionality involved.

The method of the present invention broadly comprises the steps of: collecting information relating to a particular subject; rating the information; gathering additional information relating to the rated information; indexing the rated information; identifying and applying desired client-user parameters to the rated information; identifying and applying desired end-user parameters to the rated information; and if the rated information meets the client-user and end-user parameters, displaying at least one item of information meeting the client-user and end-user parameters. The method of the present invention may further includes the steps of: managing the client-user account; and generating usage statistics.

The present invention is designed to drastically decrease the time required to search for electronic information or documents providing information on a particular subject. The information may relate to a variety of subjects, such as, for example, healthcare, automobile buying, mortgage selection, vacation planning, or any other diverse subject. With respect to the following description, the present invention will be described in the healthcare context, although such description is not intended to be limiting.

The method of the present invention first collects information relating to the particular subject, such as healthcare, as depicted in box 2A. The information may be collected manually or using a webcrawler. As is known in the art, the webcrawler is a program that systematically fetches webpages. The webcrawler works by fetching a seed page or starting page, then fetching all the pages the seed page points to, i.e. is linked to, then fetching all the pages the fetched pages from the seed page point to, etc. For example, if the present invention began with one healthcare-related webpage, the webcrawler would gather all the pages to which the original page refers, called, for example, the second group of pages. The webcrawler would then gather all the pages to which the second group of pages refers. Once gathered, each webpage or item of information is rated according to the process described below.

Next, the collected information is rated, as depicted ib box 2B, using a two-step process. First, the information is manually rated by a trained rater. The rater is preferably an employee of the administrator and is trained to quickly review and answer a plurality of questions regarding the information. For example, with regard to credibility of the information, the manual rater may answer questions such as whether the information discloses financial supporters or revenue sources. With regard to privacy, the manual rater may answer questions such as whether the information's privacy is certified by an independent third-party or whether the end-user can access meaningful information without disclosing personal information, such as a credit card number or social security number. These example questions are not meant to be limiting or exhaustive, and in operation, the manual rater may answer in excess of three hundred questions. Additionally, the options for answering each question may vary by the type of question. For example, if the question asks to what type of audience is the information intended to be read by, the rater may select from “consumer,” professional,” or “both.” If the question asks whether the information includes a stated privacy policy, the rater may select “yes” or “no.”

The answers to each question, i.e. the results of the manual rating, are condensed into at least one, but preferably more than one, administrator parameters. Each administrator parameter is assigned a value based on the results of the manual rating, as described below. Examples of the administrator parameters include demographics, including location, ownership profile, profit status, and sources of revenue; characteristics and capabilities, including languages supported, audiences targeted, reading level, types of information presented, and products and services offered; credibility and quality of information presented; privacy protection; and usability or navigability. This list of administrator parameters is not intended to be limiting or exhaustive and may be modified depending on the type of information rated. For example, information regarding mortgage selection and procurement of a mortgage would probably focus more on credibility of information and privacy protection than would information regarding vacation planning.

The value assigned to each administrator parameter is preferably based on a pre-determined scale. For example, each assigned value may range between 1 and 10, with 1 being the lowest and 10 being the highest. For example, if the information has very high privacy protection safeguards, then the information's assigned value for privacy protection may range between 8 and 10. The results of the manual rating performed by the rater are condensed using the automatic rating technique. Thus, the assigned values represent a content of each administrator parameter within the item of information. For example, if the language of the information is Spanish, then the assigned value may be “2,” such that “2” represents that the information is in Spanish.

Additional information linked or otherwise referenced by the rated information may also be gathered to ensure that the highest volume of information is available to the end-user, as depicted in box 2C. The additional information is preferably gathered using the webcrawler, as described above. In using the webcrawler, it is possible that duplicate information, i.e. duplicate webpages, will be fetched. The present invention removes the website address of duplicate webpages and near-duplicate webpages using a conventional duplicate information removal process.

The rated information is next preferably indexed based on keyword, keyword location within the information, and occurrence of keywords, as depicted in box 2D. For example, in the healthcare context, the information may be indexed based on key health-related words, such as “heart disease” and “obesity.” Any keyword search requesting information having those terms is retrievable. Additionally, the information may be indexed based on the location of the keyword within the information. For example, if the end-user was searching for information regarding “heart disease,” then any information having “heart disease” in the title may be given more weight. Further, the information may be indexed based on the occurrence of the keyword or how often the keyword appears in the information.

The rated information may be modified by rating the information again using the rating technique. This process may be repeated at pre-determined intervals, such as, for example, once per week or once per day. Application of the rating technique to already rated information is advantageous because information available on the WWW changes frequently. This ensures that the information made available to the end-user is rated and therefore, is the most appropriate and tailored information for the end-user's needs.

To retrieve and filter the rated information, the end-user may access either the administrator website 26 or the client-user website, as noted above and discussed in more detail below. If the information is accessed via the administrator website 26, then the end-user may influence, weight, or otherwise filter the rated information by applying the end-user parameters to the rated information, as depicted in box 2E. The end-user parameters may be either an absolute parameter or a preference parameter. The absolute parameter is a parameter that allows only information meeting that parameter to be retrieved. For example, if the end-user identifies privacy protection as a requirement for all information retrieved, then only those items of rated information having a high value for privacy protection, for example, between 8 and 10, are retrieved.

Alternatively, the absolute parameter may be a parameter that is selected as either “on” or “off.” For example, if the end-user wishes to only retrieve information that is accredited by a third-party, then the end-user may select “accredited.” Thus, the end-user parameter for accreditation is an example of the absolute parameter, because only information that is accredited is retrieved.

In contrast, if the end-user identifies privacy protection as somewhat of a concern, but not an absolute requirement, then the present invention retrieves items of information having a value higher than 5, for example. The preference for privacy protection, as opposed to the absolute requirement, allows more information to be retrieved. The information that has a lower assigned value for privacy protection is given less weight, and thus, when a list of the information is retrieved for viewing by the end-user, the items of information with higher privacy scores are listed before the items of information with lower privacy scores.

The end-user applies the end-user parameters to the rated information using the first interface accessible via the administrator website 26. Application of the end-user parameters to the rated information filters the information, providing a subset of information of the rated information that is tailored to the end-users' needs. Further, some of the parameters listed below retrieve certain types of websites, such as websites having message boards. Examples of end-user parameters relevant to all fields of information and types of websites retrieved include the following: accreditation; type of information, wherein the type of information is selected from government, education, non-profit organization, commercial, or information with a quality advisory board; information part of websites that offers products or services for sale; reading level; audience; quality; credibility; topic coverage; and websites that are easy to use. Further, the end-user parameters may include specific resource parameters, such as whether the retrieved information is part of websites that have message boards, chat rooms, or online tools, such as, for example, a body fat percentage calculator. Further, with regard to the healthcare field, the end-user may identify content filters, such as, for example, privacy, symptoms, prognosis, treatments, and risk factors.

As a further example of the identification and application of the end-user parameters, the end-user may choose whether selected websites are commercial or not commercial. If the end-user chooses to exclude commercial information, then the end-user selects “exclude,” thus limiting the retrievable information to only non-commercial information. In this context, the exclusion of commercial sites is an example of an absolute parameter, as discussed above. In contrast, if the end-user selects “somewhat concerned” for credibility, then the end-user is selecting a preference parameter, which excludes only information with little or no credibility. For example, information having a high numerical score for credibility, such as between 8 and 10, is listed before information having a numerical score for credibility between 5 and 7.

If the information is accessed via the client-user website, then the information is also influenced, weighted, or otherwise manipulated by application of the client-user parameters, as depicted in box 2F. As such, the information accessed via the client-user website is twice filtered—once by the client-user and once by the end-user. Similar to the end-user parameters, the client-user parameters may be either an absolute parameter or a preference parameter. The client-user parameters available for identification by the client-user are generally similar to the end-user parameters. Unlike application of the rating technique, however, which only rates and assigns numerical scores to the information and provides no filtering of the information, the application of the client-user parameters to the information filters or tailors the information, thus limiting the information accessible and retrievable through the client-user's website.

As described above, the administrator parameters are parameters used to rate the information; no information is filtered until application of the client-user or end-user parameters to the rated information. However, the administrator may filter the rated information by applying the administrator parameters as an absolute or preference parameter. For example, if the administrator wishes to only allow accredited information to be retrieved, the administrator may apply an absolute parameter such that any information retrieved from either the client-user website or the administrator website 26 is accredited. Further, the administrator may wish to filter the rated information to exclude information the administrator deems substandard in presentation, quality, content, or any other parameter. If the administrator applies administrator parameters to filter the rated information, then all information accessible via the administrator website 26 or the client-user website is already once filtered, thus affecting all retrieval of information from the administrator or client-user websites. Therefore, application of the administrator parameters results in information thrice filtered—once by application of the administrator parameters, twice by application of the client-user parameters, and thrice by application of the end-user parameters.

The administrator, client-user, or end-user may set parameters to affect information retrieval for only one search episode or for multiple search episodes. For example, if the end-user wishes all future searches performed to exclude commercial information, then the end-user may identify and save their parameters to exclude all commercial information for every performed search episode.

Once the client-user parameters and end-user parameters are identified and applied to the rated information, the information may be weighted using a weighting technique to influence the order in which the information is listed or displayed, as depicted in box 2G. The weighting technique weights the information by relevance and filters the information according to the applied client-user and end-user parameters, including application of whether the parameter is an absolute parameter or a preference parameter. Thus, varying degrees of importance may be placed on each parameter discussed above. The weighting technique then applies the chosen weights to the rated and filtered information and ranks the information by importance or relevance to the chosen parameters and any keywords identified by the end-user.

The client-user may also choose weights that are more appropriate to the desires and needs of the client-user. For example, if the client-user is a hospital that wishes to promote their cardiology unit, then the client-user may request that the administrator of the present invention weight information obtained through the client-user's website and regarding cardiology to be ranked first. Thus, if the end-user accesses the client-user's website to use the computer program of the present invention, then any information the end-user requests relating to cardiology is weighted to present the client-user's information first.

Further, the administrator of the present invention may weight the information if desired. For example, the administrator may generate income from various companies that are operating websites having information contained thereon in exchange for listing those companies' websites first or near-first in the list of retrieved information.

The method of the present invention also provides for client-user account capabilities. The client-user may access and manage their account via a secure, e.g. encrypted, client-user interface 28 accessible on the administrator website 26, as illustrated in FIG. 4. The client-user may manage their selection of applied client-user parameters, including adding or deleting client-user parameters or changing the value for the client-user parameters. Additionally, the client-user may manage the importation and application of the computer program of the present invention to the client-user website, including application of advertisements on the website. Such advertisements may be targeted messages for any end-user accessing the present invention through the client-user website, or the targeted message, for example, may appear when only certain end-user parameters are applied. For example, if the client-user has a specialized cardiology unit, then the client-user may choose to advertise their cardiology unit when the end-user searches for treatments for heart disease. Further, the client-user may manage their billing by the administrator. Other managing applications are possible, with the above-mentioned examples not intended to be limiting or exhaustive.

Further, the method of the present invention also provides statistics-generating capabilities. The administrator or client-user of the present invention may generate usage statistics for market research or academic research and studies, for example. The statistics-generating capabilities of the present invention are operable to collect depersonalized information about usage patterns from end-users accessing the computer program of the present invention through the administrator or client-user websites. The end-user parameters identified and applied by the end-users are potentially very informative, since the parameters may be used to interpret end-user desires and behavior patterns. Due to the rating technique and filtering process of the present invention as described above, the statistics collected are potentially more valuable and insightful with regard to content than other presently known usage statistics for users accessing information on the WWW.

The computer program of the present invention comprises one or more source code modules, namely a Rating Source Code Module and a Connectivity Source Code Module, co-operating in an object-oriented manner. Each source code module could be, for example, substantially independent of any other module or, alternatively, a routine or subroutine within another source code module, with each source code module including a plurality of code segments. The code segments may be written in any suitable programming language, including JAVA or C++, as a matter of design choice, and stored in or on the memory described above.

The computer program of the present invention also contains a plurality of files stored on the memory of the network server 16. The files may be substantially similar to one or more databases and one or more of the files may be stored in a database. The files will be described in more detail below with respect to the implementation of the computer program and are listed as follows: a Site Identification File; a Mapping File; a Raw Scores File; a Rated Information File; an Index File; a Text File; a Title File; and a Client-User Parameters File. The above list of files is neither limiting nor exhaustive and is only provided for describing implementation and operation of the computer program.

Each item of information to be rated is first assigned a site identification number, and the site identification number for each item of information is stored in the Site Identification File. The website address of each item of information is mapped to the assigned site identification number, and the site identification along with the respective website address is stored in the Mapping File. For example, if the website webmd.com is to be rated, webmd.com is first assigned a site identification number, such as, for example, number one. The site identification of number one along with the website webmd.com is stored in the Site Identification File. The mapping of webmd.com to the side identification number one is stored in the Mapping File.

After assigning the site identification number to the information, which is locatable on the first and second communications networks 12,14 by the website address, such as, for example, webmd.com, the information is manually rated by the rater. The rater answers the questions discussed above with regard to the method of the present invention, and the results of the questions for each item of information are stored in the Raw Scores File.

After the manual rater answers the questions and enters the answers in the computer program, the Rating Source Code Module automatically rates the information, as described above with respect to the method of the present invention. The Rating Source Code Module condenses the answers to the questions for each item of information into the value assigned to the administrator parameters. The value for each administrator parameter, along with the site identification for the information, is stored in the Rated Information File.

Additional information is gathered from the rated information by applying the webcrawler to the rated information. As described above, the webcrawler fetches webpages linked to the seed page. Once gathered, the additional information is rated by the manual rater and by the Rating Source Code Module, as described above. As previously stated, whenever a new item of information is rated, the webcrawler is automatically applied to the new information so as to gather additional information. As noted with regard to the method of the present invention, duplicate information is removed from the Rated Information File.

Once rated, the information is indexed based on keyword, keyword location within the information, and occurrence of keywords, as noted above. The Index File includes a Dictionary Subfile and at least one Post Subfile, although the Index File likely contains additional subfiles necessary for implementation of the computer program of the present invention. Since there exists a plurality of keywords contained in the information for which the end-user may search, the Dictionary Subfile preferably only includes unique words relevant to the general subject searched. Thus, if healthcare is the general subject, then the Dictionary Subfile may contain words such as, for example, diabetes, heart, obesity, Alzheimer, etc.

Each Post Subfile lists a frequency with which each unique keyword appears in each item of information. Importantly, each item of information corresponds with a separate Post Subfile, as opposed to all items of information, and the frequency of keywords within each item of information, included in one global Post Subfile. Thus, when performing a keyword retrieval of information, the computer program of the present invention may locate in realtime all information having the keyword, without needing to search a large global file.

A text of the information, along with the information's site identification number, is stored in the Text File. Additionally, a title of the information, along with the information's site identification number, is stored in the Title File. As discussed below, when the information is listed or displayed on the first or second interfaces for viewing by the end-user, the information's title, along with a summary of the information, is also listed. The title is retrieved from the Title File, and the summary of the information is retrieved from the Text File.

The client-user parameters are stored in the Client-User Parameters File. The end-user parameters need not be stored in a separate file of the computer program, since the end-user parameters are identified and the information is retrieved in realtime. Additionally, if the administrator wishes to weight or influence the retrieved information using the administrator parameters, as discussed above, the administrator parameters may be stored in a separate Administrator Parameters File.

To retrieve, weight, and list the information for the end-user in realtime, the computer program of the present invention uses the Connectivity Source Code Module. Once the end-user identifies their end-user parameters, the Connectivity Source Code Module in realtime first retrieves the end-user parameters from the End-User Parameters File (and administrator parameters if applicable). Next, the Connectivity Source Code Module retrieves the Rated Information File containing the assigned values for each administrator parameter and the site identification number for each item of information. The Connectivity Source Code Module then compares the retrieved client-user and end-user parameters and compares the identified parameters to the scores of each item of information in the Rated Information File. Since each item of information is individually rated and indexed, the computer program can, in realtime, discard the information not meeting the identified client-user and end-user parameters.

If the end-user selects one or more keywords to further filter the information, the Connectivity Source Code Module retrieves the keyword and then retrieves the Index File to determine the location and occurrence of the keyword within the information. The Connectivity Source Code Module then applies the weighting technique to the information meeting the client-user and end-user parameters and having the identified keywords. Application of the weighting technique to the information includes weighting the information based on the relevancy of keywords within the information, weighting the client-user and end-user parameters based on the absolute and preference parameters, as discussed with regard to the method of the present invention, and filtering or excluding any information not meeting the client-user or end-user parameters. From this weighting process, the weighting technique determines the ranking or ordering of the information. The computer program of the present invention is operable to constrain the list of retrieved information to a set number, such as two hundred separate items of information, for example.

Once the information is retrieved, if the end-user is accessing the computer program of the present invention through the client-user website, then the Connectivity Source Code Module retrieves the client-user template on which the end-user views the list of retrieved information. The template preferably includes the client-user's name and any other preferred identifying information, such as a telephone number and an address.

Upon retrieving the client-user template, or if the computer program is accessed through the administrator website 26, upon requesting a search, the Connectivity Source Code Module displays the list of retrieved information. Each listed item of information includes the website address retrieved from the Site Identification File, the title retrieved from the Title File, and the summary of the text retrieved from the Text File. The Connectivity Source Code Module is operable to locate the website address of each item of information in realtime since the website address is mapped to the site identification number and the Title File and Text File each include the site identification number of the information.

The computer program of the present invention may also retrieve information based on a known medical condition of the end-user. If the end-user may access their medical records via the client-user website, then the client-user may pre-set the end-user parameters for that particular end-user. For example, if the end-user is a juvenile diabetic, the computer program of the present invention is operable to automatically identify the end-user parameters to request a subject search for “diabetes,” identify the information retrieved to be “easy to read” and “easy to use,” identify the privacy requirement as “high,” and identify the viewpoint parameter as “traditional.” The end-user need only begin the information retrieval, or the end-user may identify additional parameters, if desired.

Although the invention has been described with reference to the preferred embodiment illustrated in the attached drawing figures, it is noted that equivalents may be employed and substitutions made herein without departing from the scope of the invention as recited in the claims. For example, in the preferred embodiment, the information source is the WWW. However, the present invention encompasses other electronic information sources, such as an information source that includes information that is a subset of all information available on the WWW.

Having thus described the preferred embodiment of the invention, what is claimed as new and desired to be protected by Letters Patent includes the following:

1. A method of collecting, rating, and making available electronic information comprising the steps of:
collecting information relating to a particular subject;
rating the information based on at least one first parameter;
identifying at least one second parameter selected by an end-user;
filtering the rated information based on the second parameter; and
retrieving at least one item of information from the rated information,
wherein the retrieved item of information meets the first and second parameters.

2. The method as claimed in claim 1, wherein the information is locatable on the Internet by a website address.

3. The method as claimed in claim 2, wherein rating the information includes—
manually rating the information to obtain results, and
automatically rating the information using a rating technique that condenses the results of the manual rating into at least one value that represents a content of at least one first parameter within the information.

4. The method as claimed in claim 3, wherein the second parameter is an absolute parameter, such that application of the second absolute parameter to the information excludes a subset of items of information not meeting the assigned value of the second absolute parameter.

5. The method as claimed in claim 3, wherein the second parameter is a preference parameter, which allows the end-user to identify a range within which the assigned value must lie, such that only a subset of items of information having the assigned value for the second parameter within the range is displayed, and the subset of items of information displayed is ranked according to the end-user's preference for the assigned value for the second absolute parameter.

6. A method of collecting, rating, and making available electronic information comprising the steps of:
collecting information relating to a particular subject;
rating the information based on at least one first parameter;
gathering additional information relating to the rated information;
indexing the rated information;
identifying at least one second parameter selected by an intermediate user;
filtering the rated information based on the second parameter;
identifying at least one third parameter selected by an end-user;
filtering the rated information based on the third parameter;
weighting the information; and
displaying at least one item of information meeting the second and third parameters.

7. The method as claimed in claim 6, further including the steps of:
managing an account of the intermediate user; and
generating usage statistics.

8. The method as claimed in claim 7, wherein the information is locatable on the Internet by a website address.

9. The method as claimed in claim 8, wherein rating the information includes—
manually rating the information to obtain results, and
automatically rating the information using a rating technique that condenses the results of the manual rating into at least one value that represents a content of at least one first parameter within the information.

10. The method as claimed in claim 9, wherein the first parameters are selected from the group consisting of: credibility of the information and degree of privacy protection of the information.

11. The method as claimed in claim 10, wherein the additional information is gathered using a webcrawler.

12. The method as claimed in claim 11, wherein the information is indexed based on keyword, keyword location within the information, and occurrence of the keywords within the information.

13. The method as claimed in claim 12, wherein the second parameter is selected from the group consisting of: intended audience, credibility, and ease of use.

14. The method as claimed in claim 13, wherein the second parameter is an absolute parameter, such that application of the second absolute parameter to the information excludes a subset of information not meeting the assigned value of the second absolute parameter.

15. The method as claimed in claim 14, wherein the second parameter is a preference parameter that allows the end-user to identify a range within which the assigned value must lie, such that only a subset of information having an assigned value for the second parameter within the range is displayed, and the subset of information displayed is ranked according to the end-user's preference for the assigned value for the second absolute parameter.

16. A method of filtering information comprising the steps of:
selecting at least one parameter for filtering the information;
assigning at least one value to the information, wherein the value is representative of a content of the parameter in the information;
determining a range within which the assigned value for the parameter must lie; and
applying the parameter to the information so as to filter the information by excluding a subset of information having an assigned value outside the determined range.

17. The method as claimed in claim 16, wherein the information is locatable by a website address and related to a particular subject.

18. The method as claimed in claim 17, wherein the parameter is an absolute parameter.

19. A method of rating information comprising the steps of:
manually rating the information by evaluating a plurality of features of the information, wherein the plurality of features are generally related to at least one parameter; and
automatically rating the information by condensing the evaluation of the plurality of features into at least one value representative of a content of the parameter within the information.

20. The method as claimed in claim 19, wherein the manually rating is performed by a trained manual rater.

21. The method as claimed in claim 20, wherein evaluating a plurality of features of the information comprises answering a plurality of questions about the information.

22. The method as claimed in claim 21, wherein the information is automatically rated using a rating technique.

23. A computer program for collecting, rating, and making available electronic information, the computer program comprising:
a code segment operable to collect information relating to a particular subject;
a code segment operable to rate the information based on at least one first parameter;
a code segment operable to gather additional information relating to the rated information;
a code segment operable to index the rated information;
a code segment operable to identify at least one second parameter selected by an intermediate user;
a code segment operable to filter the rated information based on the second parameter;
a code segment operable to identify at least one third parameter selected by an end-user;
a code segment operable to filter the rated information based on the third parameter;
a code segment operable to weight the information; and
a code segment operable to display at least one item of information meeting the second and third parameters.

24. The computer program as claimed in claim 23, further comprising—
a code segment operable to manage an account of the intermediate user; and
a code segment operable to generate usage statistics.

25. The computer program as claimed in claim 24, wherein the code segment operable to rate the information includes—
a code segment operable to receive results of a manual rating process performed by a trained rater, and
a code segment operable to automatically rate the information using a rating technique that condenses the results of the manual rating process into at least one value that represents a content of at least one first parameter within the information.

26. A computer program for collecting, rating, and making available electronic information, the computer program comprising:
a code segment operable to collect information relating to a particular subject;
a code segment operable to rate the information based on at least one first parameter;
a code segment operable to identify at least one second parameter selected by an end-user;
a code segment operable to filter the rated information based on the second parameter; and
a code segment operable to retrieve at least one item of information from the rated information, wherein the retrieved item of information meets the first and second parameters.

27. The computer program as claimed in claim 26, wherein the code segment operable to rate the information includes—
a code segment operable to receive results of a manual rating process performed by a trained rater, and
a code segment operable to automatically rate the information using a rating technique that condenses the results of the manual rating process into at least one value that represents a content of at least one first parameter within the information.
